(19) United States
(12) Patent Application Publication
(10) Pub. No.: US 2016/0155150 A1
(43) Pub. Date: Jun. 2, 2016

(54) CREATING AN ANNOTATION FOR A SIGNAGE

(71) Applicant: Verizon Patent and Licensing Inc., Arlington, VA (US)

(72) Inventors: Ning ZHANG, Warren, NJ (US); Yuk Lun LI, Morganville, NJ (US); Brigitte BASTALDO-TSAMPALIS, Bridgewater, NJ (US)

(73) Assignee: Verizon Patent and Licensing Inc.

(21) Appl. No.: 14/558,408

(22) Filed: Dec. 2, 2014

(51) Int. Cl. G06Q 30/02

(52) U.S. Cl. CPC G06Q 30/0261

(57) ABSTRACT

A signage application of a mobile device receives a request for information relating to a signage. The request includes a keyword associated with the signage. Responsive to the request, the signage application identifies a location associated with the mobile device. The signage application sends to a signage server the location and the keyword to receive the requested information about the signage. In response, the signage server provides the requested information about the signage to the signage application.

### BACKGROUND

Currently there does not exist a seamless methodology to create an annotation for a signage. Methodologies such as Quick Response (“QR”), hand writing, taking a picture, or texting are methods that require highly active engagement and furthermore, require the mobile user to stop their mobility when interacting with the signage. For example, a person may drive by a billboard or an advertisement sign and may like the advertisement seen but does not have enough time to note down the information before the user passes the billboard or the advertisement sign. Another person may walk by a store, a place, or a sign and may like what he or she sees and may want to note it down but does not have enough time to do so. Hence, there is a need for a seamless creation of annotation for a signage.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an exemplary system offering a variety of mobile communication services, including communications service to allow a user to receive an annotation for a signage;

FIG. 2 illustrates an exemplary process for receiving an annotation for a signage from the signage server shown in FIG. 1;

FIG. 3 illustrates an exemplary interaction between the signage application, the client application, and the signage server shown in FIG. 1;

FIG. 4 illustrates an exemplary monetization of the client application and the signage application shown in FIG. 1;

FIGS. 5A and 5B respectively illustrate an exemplary user interface 500A showing detected annotations and an exemplary user interface showing saved annotations;

FIG. 6 illustrates exemplary backend settings on the mobile device shown in FIG. 1;

FIG. 7 illustrates an exemplary application store interface showing the available applications for download to the mobile device shown in FIG. 1;

FIG. 8 illustrates an exemplary set up interface for display on the client application shown in FIG. 1;

FIG. 9 illustrates an exemplary analytics interface that may be sent from time to time from the signage server to the client application shown in FIG. 1;

FIG. 10 is a high-level functional block diagram of an exemplary non-touch type mobile device that may utilize the signage service through a network/system like that shown in FIG. 1;

FIG. 11 is a high-level functional block diagram of an exemplary touch screen type mobile device that may utilize the signage service through a network/system like that shown in FIG. 1;

FIG. 12 is a simplified functional block diagram of an exemplary computer that may be configured as a host or server such as signage server shown in FIG. 1; and

FIG. 13 is a simplified functional block diagram of an exemplary personal computer or terminal device such as the mobile device or the client device shown in FIG. 1.

### DETAILED DESCRIPTION

In the following detailed description, numerous specific details are set forth by way of examples in order to provide a thorough understanding of the relevant teachings. In other instances, well known methods, procedures, components, and/or circuitry have been described without detail at a relatively high-level in order to avoid unnecessarily obscuring aspects of the present teachings.

The techniques disclosed herein relate to a seamless process to create an annotation for a signage. The signage may include a billboard, store front, television screen in an elevator, or some other type of medium that includes information such as, for example, an advertisement. The mediums, regardless of their type, may share one common feature—they may have a fixed location. The signage technology described in the present application mobilizes the fixed location of the signage. Mobilizing the fixed location of the signage may mean allowing customers to decide when they want relevant signage direct messaging to happen without having to stop their mobility.

To this end, the signage technology of the present application includes a client application, a signage application, and a signage server. The client application may be utilized by an advertiser or an advertising agency to register information about the signage. The information may include a signage location, a keyword, and a message to be displayed on the signage application triggered based on a request for the advertisement from the user. The signage location may include the physical or geographic location of the signage. The physical location may be determined in multiple different ways, for example, using a global positioning system (GPS), using triangulation of cellular tower signals, using one or more visible WiFi networks and a data repository that associates visible WiFi network(s) with geographic locations, using a user input of a street address (e.g., 123 Main Street) or a nearby location of import (e.g., near Starbucks®) etc. The keyword may include one or more words and/or phrases that the user may associate with and remember about the signage when the user first experiences the signage. The keyword may be provided within the signage, for example, a signage that includes the word “KLEENEX®” written in large capital letters may have the keyword “Kleenex®.” Alternatively, the user may be able to infer the keyword from the signage. For example, a video advertisement that features a monkey may have the keyword “monkey.” In some cases, a signage may be associated with multiple keywords. For example, a signage in an airport that advertises a duty free store selling whiskey and has a picture of a bull drinking the whiskey may have the keywords “duty free,” “whiskey,” and “bull.” The message may include detailed information about the signage. For example, assuming the signage is an advertisement, the message may include detailed advertising information relating to the specific advertisement placed on the signage.

Responsive to the request to register information about the signage, the signage server registers the requested information in a database. Thereafter, when a user with a mobile device sees the signage, for example, on the road or in the mall, he or she can use the signage application on the user's mobile device to submit a query to the signage server to receive annotations relating to the signage. The query may include a keyword associated with the signage and location information associated with the mobile device. The keyword may include a word that may be easily retained by the user passing by the advertisement. The location information may include Global Positioning System (“GPS”) location information associated with the mobile device. In some cases, the location information may be added to the query automatically and without user input. For example, when the user submits a query, the location may be determined using the GPS if the GPS is available and turned on or using cellular tower triangulation or visible WiFi networks otherwise. In some cases, a high resolution (e.g., within a 50 or 100 meter radius) version of the location may be used. Alternatively, only a low resolution version (e.g., within a 10 kilometer radius) of the location may be used in a geographic area where there are few signages implementing the subject technology. For example, if there are few signage implementing the subject technology in Berlin, N.H., simply determining (e.g., from a single accessible cellular tower) that the mobile device's location is Berlin, N.H. may be sufficient. In some cases, the query may be used without any geographic information. For example, if only a single signage has the keyword “yellow pony,” then indicating the keyword “yellow pony” without a geographic location (or with a low resolution geographic location) may be sufficient. The signage server receives the query from the signage application, and based on the keyword and the location information included in the query, identifies information associated with the signage. To this end, the signage server may determine whether the location and the keyword received from the signage application matches the location information and the keyword received from the client application. Upon determining the location and the keyword received from the signage application matches the location information and the keyword received from the client application, the signage server sends the resulting message, including the additional information about the signage requested from the signage application, to the signage application for display on the mobile device. Upon determining that the location and the keyword received from the signage application does not match the location information and the keyword received from the client application, the signage server sends a message to the signage application indicating no information relating to the submitted keyword within the proximity of the location of the mobile device can be identified. At the time of signup, the user can choose within the signage application their preferred method (either by messages or emails) of receiving communications (e.g., the advertisement content message) from the signage server. In some cases, the user may set the preferred method of receiving communications based on the category of signage or based on the type of additional information provided. For example, the user may prefer to receive information related to immediate “impulse-type” purchases (e.g., cereal at the supermarket, lunch at a diner on a highway, souvenirs at the airport, etc.) as messages provided to the signage application and information related to more complex long-term purchases (e.g., cars, televisions, investment account management services, etc.) as email. In some implementations, the user may prefer to receive textual and image information by messages and audio or video information by email, or the user may prefer to receive short information (e.g., videos shorter than 30 seconds or text shorter than 200 characters) by messages and longer information by email.

The signage application may be voice activated using the voice command function in the mobile phone. To illustrate one specific example, the user is in a car traveling along a freeway when he sees a signage (e.g., a billboard) including an advertisement that is appealing to the user's interest. Since the user is driving (perhaps quickly), the user may only be able to retain some but not all of the advertisement information on the billboard. If the user is interested in viewing all or some of the information on the billboard at a later time without having to stop to write down the information, the user can use the signage application on his/her mobile device. The signage application interacts with the signage server to seamlessly create a personal annotation relating to the signage. For example, the user driving down a freeway sees a billboard for “Pedemerge,” a pediatrician service that opens 7 days a week. The user passes by too quickly and is unable to note down the number. However, by using hands-free operation the user can query the service about an emergency pediatric service. The service, using the user's location (with some range given the car's speed, which may be determined by comparing user's current location with the user's location a certain amount of time (e.g., 30 seconds, 1 minute, etc.) in the past or in the future and dividing the distance traveled by the time elapsed), locates the billboard in question that is registered in the service. The associated information is then sent to the user's device to be stored for later retrieval.

Reference now is made in detail to the examples illustrated in the accompanying drawings and discussed below.

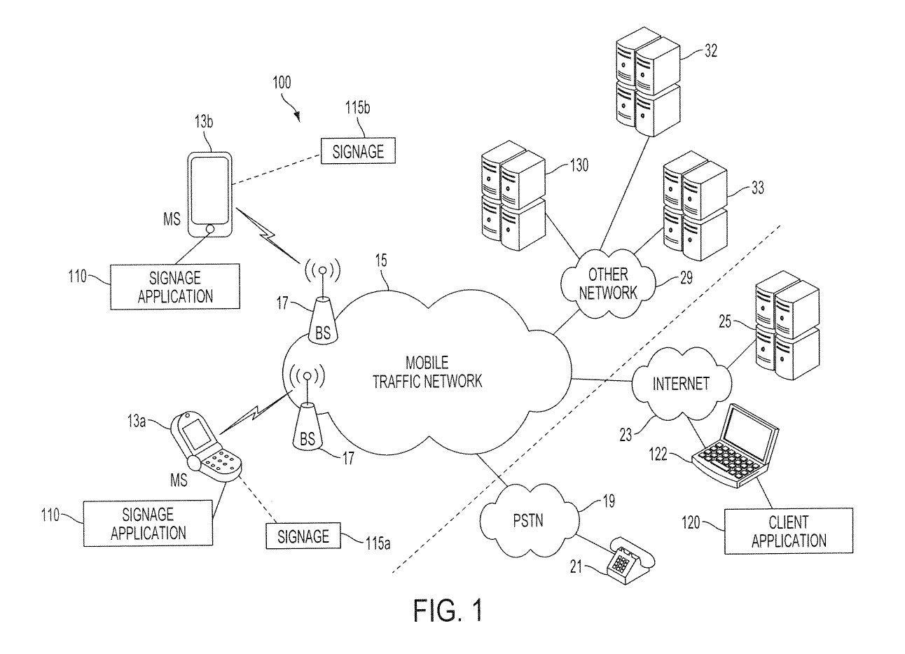

FIG. 1 illustrates an exemplary system 100 offering a variety of mobile communication services, including communications service to allow a user to receive an annotation for signage. The example shows simply two mobile devices (MSs) 13a and 13b as well as a mobile communication network 15. The stations 13a and 13b are examples of mobile devices including a signage application 110. The signage application 110 may be configured to query the system 100 for information about the signage 115a or 115b, located in the same geographic area (e.g., within 100 meters) as the corresponding mobile stations 13a or 13b, using keywords and location information associated with the mobile devices 13a or 13b and responsive to the query receive from system 100 annotations for the signage 115a or 115b. However, the network 100 will provide similar communications for many other similar users as well as for mobile devices that are interested in receiving annotations for signage 115a or 115b seen by the users. The network 15 provides mobile wireless communications services to those stations as well as to other mobile devices (not shown), for example, via a number of base stations (BSs) 17. The present techniques may be implemented in any of a variety of available mobile networks 15 and/or on any type of mobile station compatible with such a network 15, and the drawing shows only a very simplified example of a few relevant elements of the network 15 for purposes of discussion here.

The wireless mobile communication network 15 might be implemented as a network conforming to the code division multiple access (CDMA) IS-95 standard, the 3rd Generation Partnership Project 2 (3GPP2) wireless IP network standard or the Evolution Data Optimized (EVDO) standard, the Global System for Mobile (GSM) communication standard, a time division multiple access (TDMA) standard, or other standards used for public mobile wireless communications. The mobile devices 13a and 13b may be capable of voice telephone communications through the network 15. The mobile devices 13a and 13b may also take advantage of other services provided by the network 15 such as, for example, a service for receiving the annotations relating to the signage 115a or 115b.

To this end, the system 100 includes a signage application 110, a client application 120, and a signage server 130. The signage application 110 may be installed on the mobile devices 13a and 13b. The client application 120 may be installed on a client device 122. The client device 122 may include a personal computer. However, the client device 122 can take the form of portable handsets, smart-phones, or personal digital assistants, although they may be implemented in other form factors. The client device 122 may be associated with an advertiser and/or an advertising agency. The advertiser may include a person who owns the signage or has direct access to the signage 115a or 115b (e.g., store front signage). The advertising agency may include a person or an agency, such as a billboard owner that does not own nor have direct access to the signage 115a or 115b.

The signage application 110 may be preinstalled on the mobile devices 13a and 13b. Alternatively, the signage application 110 may be downloaded over the air on the mobile devices 13a and 13b. In yet another alternative, the signage application 110 may be cloud based residing on the signage server 130 and may be remotely accessed over the internet. Similarly, the client application 120 may be previously installed on the client device 122. Alternatively, the client application 120 may be downloaded over the air on the client device 122. In yet another alternative, the client application 120 may be cloud based residing on the signage server 130 and may be remotely accessed over the internet. In one specific example, the signage application 110, the client application 120, and the signage server 130 are provided by a mobile communication network provider such as, for example, Verizon Wireless™. The mobile communication network provider may provide free access to the signage application 110 and the client application 120. For example, free access to the client application 120 may be provided to an advertiser who subscribes to the services of the mobile communication network provider. Similarly, free access to the signage application 110 may be provided to a user of the mobile device 13a or 13b who subscribes to the services of the mobile communication network provider. To this end, the applications 110 and 120 may be preinstalled (or may be available for download) on the mobile device 13a or 13b and the client device 122 as a part of an existing service. Other users (e.g., advertisers and mobile device users) who do not subscribe to services of the mobile communication network provider may be able to access the applications 110 and 120 by registering for the signage service provided by the mobile communication network provider.

Using the client application 120 on the client device 122 the advertiser may register information in the signage server 130 relating to the signage 115a or 115b. The information may include a keyword, the location of the signage, and content to be displayed on the mobile device when the user queries the signage server 130 for information about the signage 115a or 115b. The keyword may include a word associated with the advertisement signage 115a or 115b that is likely to be remembered by the user when the user sees the advertisement signage 115a or 115b for a brief period of time. In keeping with the previous example, the user driving down a freeway may briefly see a billboard for “Pedemerge,” a pediatrician service that opens 7 days a week. The words that may be remembered by the user may include “Pedemerge” and/or pediatric service; therefore, “Pedemerge” and/or pediatric service may be selected as keywords for registration in the signage server 130. The keywords may be later used to retrieve the detailed information about the signage 115a or 115b that the user was not able to write down at the time when he/she first noticed the signage 115a or 115b. To this end, the keyword may be a word that is prominently displayed on the signage 115a or 115b (e.g., “Pedemerge”) or it may not be any specific word noted on the signage 115a or 115b but one that is easily associated with a signage 115a or 115b (e.g., pediatric).

As noted above, other information that may be registered in the signage server 130 may include the location of the signage 115a or 115b and the content of the signage. The location 115a or 115b of the signage may include a physical location of the signage 115a or 115b. In keeping with the previous example, the location may correspond to the physical location of the billboard along the freeway. Using a GPS, the advertiser may identify the physical location of the signage 115a or 115b (e.g., latitude and longitude) and may register this information in the signage server 130. The content of the advertisement may include a website, phone number, name or address of a business, or any other information the advertiser may want the user to remember. In keeping with the previous example, the content may include the name, address, and phone number of the pediatric service.

The signage server 130 receives from the client application 120 the request to register the information (e.g., the keywords, the location, and the content) about the signage 115a or 115b. Responsive to the request, the signage server 130 registers the information about the signage 115a or 115b in a database. In one specific implementation, the signage server 130 may first determine whether the selected keywords have been previously registered by another advertiser within the same location range. If so, the signage server 130 may notify the advertiser and may suggest to the advertiser to select other keywords. To this end, the signage server 130 may even help the advertiser to select alternative keywords that are not already registered within the signage server 130. In yet another alternative, the signage server 130 may allow the advertiser to keep the redundant keywords. This results in the display of multiple advertisements on the user's device when the commonly shared keyword is submitted to the signage server 130 via the client application 110. The signage server 130 may provide an option to the advertiser to have his/her advertisement displayed as a first advertisement among the list of advertisements on the user's device when the commonly shared keyword is submitted to the signage server 130. In some cases, multiple advertisers may select the option to have their advertisements displayed first, resulting in a conflict. The conflict may be resolved in multiple ways. In some cases, a random number generator may be used to select one of the advertisers whose advertisement will be displayed first. In some cases, different advertiser's advertisements may be displayed first at different times (e.g., one advertiser's advertisements are displayed on odd numbered calendar days and another advertiser's advertisements are displayed first on even numbered calendar days). In some examples, an auction may be used and advertisers may “bid” on having their advertisements displayed first. The winning bidder may make a payment to an owner or operator of the signage server 130.

The signage application 110 may be used to receive from a user of the mobile device 13a (or 13b) a request for information relating to a signage. The request may include a keyword associated with the signage 115a or 115b. The keyword may include a word or a phrase retained by the user who has passed by the signage 115a or 115b fairly quickly and has not been able to record all the necessary information. The keyword may not be related to any words in the signage and may be inferred from the signage by the user. For example, a user may use the keyword “monkey,” for a video advertisement that features a monkey. A billboard that shows a bull drinking coffee may use the keywords “bull” or “coffee,” even if the words “bull” or “whiskey” are not written on the billboard. In some cases, typing or spelling errors made by the user may be corrected. For instance, the incorrectly typed word “munky,” may be interpreted by the signage server 130 as referring to the word “monkey.” In keeping with the previous example, the user driving down a freeway sees a billboard for “Pedemerge,” a pediatrician service that is open 7 days a week. The user passes by too quickly to be able to write down the address and the number associated with the practice. However, the user may remember that the signage 115a or 115b was related to pediatric service. Therefore, using the signage application 110 the user may submit the keyword “pediatric service” to the signage server 130. In response to receiving the request, the signage application 110 may identify a location associated with the mobile device 13a or 13b. The signage application 110 may then send to the signage server 130 the identified location and the keyword. In response, the signage server 130 may provide the signage application 110 with the requested information about the advertisement.

Prior to receiving the request, the signage application 110 may have to be activated. The signage application 110 may be activated in a variety of manners. For example, the signage application 110 may be manually activated by the user selecting the application 110 on the mobile device 13a or 13b. Alternatively, the application 110 can be voice activated using the voice command function in the mobile phone. For example, the user may speak to the device and say “Billboard [keyword]” to activate the application 110 and provide the keyword at the same time. Alternatively, the user may first activate the application 110 by speaking to the device and saying “Billboard” and in response the application 110 requests a keyword. The user may then provide the application 110 with the keyword. In yet another alternative, the signage application 110 may be activated using speed of travel associated with the mobile device. For example, drivers of cars typically slow down when they see a billboard that interests them. A mobile station 13a or 13b with its GPS turned on may detect, by dividing the distance traveled by the time elapsed in two or more position and time measurements, that the mobile station 13a or 13b is travelling at a driving speed (e.g., between 30 kilometers per hour and 150 kilometers per hour) and slowing down. The signage application 110 may be activated responsive to this slowing down. In yet another alternative, the signage application 110 may be activated upon determining a navigation system in a vehicle has been turned ON.

At the time of the activation or thereafter, the user may manually provide the keyword to the signage application 110 or may provide the keyword to the signage application 110 via a voice command. Upon receiving the keyword, the signage application 110 identifies the location associated with the mobile device 13a or 13b. In one implementation, the signage application 110 may identify the location associated with the mobile device 13a or 13b using a GPS. The mobile device 13a or 13b may include a GPS and may communicate GPS location information to the signage server 130. The signage server 130 may require that the mobile station 13a or 13b is within a predetermined radius (e.g., 1 kilometer, 5 kilometers, 10 kilometers, etc.) of the signage 115a or 115b to receive information related to the signage. This allows the user some time to activate the signage application 110 and request the information, while reducing the probability that incorrect information is provided. In some cases, the predetermined radius may be determined based on the location(s) of other signages having similar keywords, so that the user does not receive information associated with a signage different from the one the user requested.

For location based services, including identifying location of the mobile device 13a or 13b, network 100 may also include PDE 32. In assisted GPS type deployments, for example, PDE 32 provides data to mobile device 13a or 13b to expedite satellite acquisition; it may determine the actual latitude and longitude (final fix) of mobile device 13a or 13b based on GPS measurements taken by mobile device 13a or 13b at the PDE's 32 request. The process of locating the mobile device 13a or 13b may involve several elements. In practice, the mobile device 13a or 13b may submit the request through Verizon™ and to the server 130. In response, the server 130 requests location information for a particular mobile device 13a or 13b from PDE 32. The PDE 32 utilizes different techniques to provide a reliable position location for the mobile device 13a or 13b. In one scenario, in which mobile device 13a or 13b has a clear view of the sky, PDE 32 may be using GPS signals for position determination. If the mobile device 13a or 13b does not receive sufficient GPS signals, the PDE 32 may use a combination of GPS and a pilot signal provided by a base transceiver system (BTS), such as, for example, BTS associated with the base station 17 for position determination. To this end, if the mobile device 13a or 13b receives no GPS signals, PDE 32 may use the pilot signals provided by two or more of the BTSs, assuming there are sufficient numbers of them to enable trilateration, and may calculate through vector math the location of the mobile device 13a or 13b. Alternatively or additionally, if the mobile device 13a or 13b reports that it hears two or more pilot signals associated with two or more BTSs, PDE 32 identifies the location of the mobile device 13a or 13b to be in the area where the footprints of the two or more BTSs overlap.

To perform these calculations, PDE 32 may reference a database. The database may be referred to as a Base Station Almanac Database. The network elements that can be ranged to terrestrially are identified in the database. When the mobile device 13a or 13b detects a pilot signal during a location assessment attempt, the mobile device 13a or 13b reports the pilot signal that it hears. This information is sent to the network and routed to PDE 32. In this manner, the mobile device 13a or 13b identifies to PDE 32, the sector that is serving mobile device 13a or 13b and possibly one or more other base station sector pilots that it hears (for sectors nearby but not currently servicing the mobile device 13a or 13b).

The PDE 32 will reference the database to determine what are the appropriate properties of those BTSs that can be heard and with the information that is available makes its calculation as best as possible. In one implementation, the database includes, for each pilot signal, a sector identification label, a coordinate pair associated with the source of the pilot signal, and/or a Maximum Antenna Range (MAR) value field which defines a reasonable boundary for the coverage footprint of the source of the pilot beacon signal. In yet another alternative, the PDE 32 may associate the location of the mobile device 13a or 13b with a location registered for the Wi-Fi network the mobile device 13a or 13b is accessing.

The mobile device 13a or 13b sends the location information to the signage server 130 along with the keyword. As noted above, the location information may include the actual location or information for obtaining the actual location (e.g., identity of Wi-Fi network connected to the mobile device 13a or 13b or pilot signals heard by the mobile device 13a or 13b). The signage server 130, upon receiving the keyword and the location information from the mobile device 13a or 13b, uses this information to identify the advertisement associated with the keyword and located within the proximity of the location of the mobile device 13a or 13b. The signage server 130 then sends the information associated with the advertisement to the signage application 110. The signage application 110 displays the requested information about the advertisement on the mobile device 13a or 13b. The signage application 110 may thereafter receive, from the user, an instruction to store or disregard the information about the advertisement. Based on the received instructions, the signage application 110 accordingly either stores or discards the information about the advertisement.

To identify the information associated with the advertisement, the signage server 130 determines whether the location and the keyword received from the signage application 110 matches the location information and the keyword received from the client application 120. Upon determining that the location and the keyword received from the signage application 110 matches the location information and the keyword received from the client application 120, the signage server 130 sends the resulting message to the signage application 110 for display on the mobile device 13a or 13b. Upon determining that the location and the keyword received from the signage application 110 does not match the location information and the keyword received from the client application 120, the signage server 130 sends a message to the signage application 110 indicating no information relating to the submitted keyword within the proximity of the location of the mobile device 13a or 13b can be identified.

The devices 13a and 13b can utilize the network 15 to place and receive telephone calls to each other as well as through the public switched telephone network or “PSTN” 19 and telephone stations 21 connected to the PSTN. The network 15 typically offers a variety of data services via the internet 23, such as downloads, web browsing, email, etc. By way of example, the drawing shows a laptop PC type user terminal 122 as well as a server 25 connected to the internet 23. The data services for the mobile devices 13a and 13b via the internet 23 may be with devices like those shown as server 25 and user terminal 122 as well as with a variety of other types of devices or systems capable of data communications through various interconnected networks. The mobile devices 13a and 13b also can receive and execute applications written in various programming languages such as, for example, the signage application 110 discussed above.

Mobile devices 13a and 13b can take the form of portable handsets, smart-phones or personal digital assistants, although they may also be implemented in other form factors. For example, a mobile station application can be written to execute on a binary runtime environment for a (BREW-based) mobile station, a Windows Mobile based mobile station, Android, iPhone™, Java Mobile, or RIM based mobile station such as a BlackBerry™ or the like. Some of these types of devices can employ a multi-tasking operating system.

The mobile communication network 100 can be implemented by a number of interconnected networks. Hence, the overall network 100 may include a number of radio access networks (RANs), as well as regional ground networks interconnecting a number of RANs and a wide area network (WAN) interconnecting the regional ground networks to core network elements. A regional portion of the network 100, such as those serving mobile devices 13a and 13b, can include one or more RANs and a regional circuit and/or packet switched network and associated signaling network facilities.

Physical elements of a RAN operated by one of the mobile service providers or carriers include a number of base stations represented in the example by the base stations (BSs) 17. Although not separately shown, such a base station 17 can include a BTS, which can communicate via an antennae system at the site of base station and over the airlink with one or more of the mobile devices 13, when the mobile devices are within range. Each base station can include a BTS coupled to several antennae mounted on a radio tower within a coverage area often referred to as a “cell.” The BTS is the part of the radio network that sends and receives RF signals to/from the mobile devices 13a and 13b that are served by the base station 17.

The radio access networks can also include a traffic network represented generally by the cloud at 15, which carries the user communications and data for the mobile devices 13a and 13b between the base stations 17 and other elements with or through which the mobile devices communicate. The network can also include other elements that support functionality other than device-to-device media transfer services such as messages and voice communications. Specific elements of the network 15 for carrying the voice and data traffic and for controlling various aspects of the calls or sessions through the network 15 are omitted here form simplicity. It will be understood that the various network elements can communicate with each other and other aspects of the mobile communications network 100 and other networks (e.g., the public switched telephone network (PSTN) and the Internet) either directly or indirectly.

The carrier will also operate a number of systems that provide ancillary functions in support of the communications services and/or application services provided through the network 100, and those elements communicate with other nodes or elements of the network 100 via one or more private IP type packet data networks 29 (sometimes referred to as an Intranet), i.e., private networks. Generally, such systems are part of or connected for communication via the private network 29. A person skilled in the art, however, would recognize that systems outside of the private network could serve the same functions as well. Examples of such systems, in this case operated by the network service provider as part of the overall network 100, which communicate through the intranet type network 29, include one or more application servers 130 and a related authentication server 33 for the application service of server 31.

A mobile device 13a or 13b communicates over the air with a base station 17 and through the traffic network 15 for various voice and data communications, e.g. through the internet 23 with a server 25 and/or with application servers 130. If the mobile service carrier provides a signage service for automating interaction with a signage, as noted above the service may be hosted on a carrier-operated application server 130. The application server 130 may communicate with the devices 13a and 13b via the networks 15 and 29. Alternatively, the signage service may be hosted on an application server such as server 25 connected for communication via the networks 15 and 23. Servers such as 25 and 130 may provide any of a variety of common application or service functions in support of or in addition to application programs running on the mobile devices 13a and 13b. However, for brevity of description and simplicity, we focus on functions thereof in support signage service. For a given service, including the signage service, an application program within the mobile station may be considered as a ‘client’ and the programming at 25 or 130 may be considered as the ‘server’ application for the particular service.

To insure that the application service (e.g., the signage service) offered by server 130 is available to only authorized devices/users, the provider of the application service also deploys an authentication server 33. The authentication server 33 could be a separate physical server as shown, or could be implemented as another program module running on the same hardware platform as the server application 130. Essentially, when the server application (server 130 in our example) receives a service request from a client application 110 on a mobile device 13a or 13b to receive information about an advertisement, the server application provides appropriate information to the authentication server 33 to allow server 33 to authenticate the mobile device 13a or 13b as outlined herein. Upon successful authentication, the server 33 informs the server 130, which in turn provides access to the service via data communication through the various communication elements (e.g. 29, 15 and 17) of the network 100. For example, the server 130 sends a request to the PDE 32 to identify the location of the mobile device 13a or 13b. In response, the PDE 32 identifies the location of the mobile device 13a or 13b and sends this information to the server 130. The server 130 uses the location information along with the keyword to identify the advertisement requested by the user.

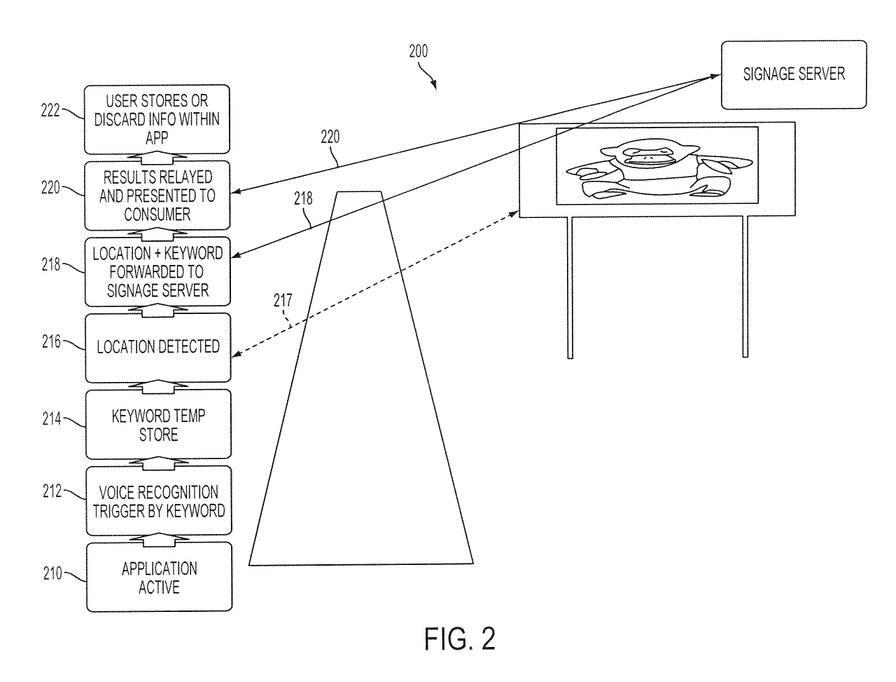

FIG. 2 illustrates an exemplary process 200 for receiving an annotation for a signage from the signage server shown in FIG. 1. In keeping with the previous example, the process 200 is described in respect to a billboard positioned along a freeway. However, the process 200 is not limited to the interaction with only this type of media. For example, the process 200 may equally work with a storefront signage, venue signage, and an elevator signage, etc. The process 200 begins with activating the signage application on the mobile device (Step 210). The signage application may correspond to the signage application 110 described with respect to FIG. 1. The signage application may be activated in a variety of manners. For example, the signage application may be manually activated by the user selecting the application on the mobile device. Alternatively, the application can be voice activated using the voice command function in the mobile phone. For example, the user may speak to the device and say “Billboard [keyword]” to activate the application and provide the keyword at the same time. Alternatively, the user may first activate the application by speaking to the device and saying “Billboard” and in response the application requests a keyword from the user. The user may then input the keyword into the application.

Once activated, the signage application voice recognition is triggered by a keyword (Step 212). The voice recognition may be triggered by a keyword associated with the signage the user is passing by. In one specific example, as shown in FIG. 2 of the instant application, the signage is a billboard showing a picture of a monkey; therefore, the keyword may be the word “monkey.” Upon receiving the keyword, the signage application may confirm the accuracy of the keyword. For example, the signage application may display on the mobile device the keyword and ask the user to approve the keyword. The user may approve or disapprove the keyword by selecting a specific key such as, for example, “Yes” or “No” on the display of the mobile device. Alternatively, the user may approve or disapprove the keyword by selecting a specific numeral key (e.g., numeral key 1 or 2) on the keypad of the mobile device. In yet another alternative, the user may approve or disapprove the keyword via a voice command such as “Yes” or “No.” In some examples, the signage application may provide an audio output of the keyword and ask the user to orally approve the keyword (e.g., by saying “Yes,” or “No”). This may be useful, for instance, if the user is driving or otherwise unable to look at the mobile device.

Upon receiving the user's approval (if one is needed), the signage application temporarily stores the keyword (Step 214) and identifies the location associated with the mobile device (Step 216). The signage application may identify the location immediately or may identify the location after passing of the threshold of time. Alternatively, the signage application may identify the location immediately and may also identify the location after passing of the threshold of time. Alternatively, the signage application may identify the location immediately and may continue to monitor the location of the mobile device for a threshold period of time and continuously update the location if the location is changed more than a threshold amount. Among the one or more locations identified, the location best matched with a location within the signage server and corresponding to the billboard associated with the keyword may be used. The best matched location may be the location that is most proximate to the billboard or most proximate to a position from which the billboard is typically viewed. However, in some cases, the user may transmit the request for information about the signage after the user has moved away from the signage. Thus, the best possible matched location may not be provided, and other location(s), within a certain distance (e.g., one kilometer or five kilometers) of the best possible matched location may be provided instead. The request may be received with or without the mobile device directly facing the signage.

As noted above, the location of the mobile device may be determined in a number of ways. For example, the location of the mobile device may be determined based on a GPS location of the mobile device or based on a short range connectivity of the mobile device. Alternatively, the location of the mobile device may be determined using triangulation of cellular tower signals, using one or more visible WiFi networks and a data repository that associates visible WiFi network(s) with geographic locations, using a user input of a street address (e.g., 123 Main Street) or a nearby location of import (e.g., near Starbucks®) etc. According to some examples, the mobile device may first attempt to identify its location based on GPS information. However, if the mobile device 13a or 13b does not receive sufficient GPS signals, the mobile device 13a or 13b may resort to other location based services for identifying the location of the mobile device 13a or 13b such as, for example, short range connectivity or pilot signals providing mobile connectivity to the mobile device 13a or 13b.

The short range connectivity may include connectivity with a short range network such as, for example, Wi-Fi or Bluetooth. For example, if the mobile device is within a range of a Wi-Fi network, it can identify the MAC address of the Wi-Fi network and obtain location information associated with the MAC address. To this end, the signage application may send the MAC address to the server in the network such as, for example, PDE 32 and requests for location associated with the MAC address. Upon obtaining the location information, the signage application may then forward the location information along with the keyword to the signage server. In yet another alternative, the signage application may forward the keyword along with location information such as the MAC address to the signage server and the signage server instead of the signage application may obtain the actual location associated with the MAC address. The signage server may obtain the actual location associated with the MAC address by communicating with the PDE 32.

The short range connectivity may also include connectivity with the signage, a base station, or a pilot beacon placed indoors to extend coverage of the mobile server from outdoor to indoor. The signage may be configured to broadcast a specific ID, which may be picked up by the signage application when the mobile device is within the proximity of the signage (Step 217). The signage ID may have been previously registered at the signage server and/or the PDE 32 and associated with a specific location. When the signage application receives a specific keyword relating to the signage, the signage application monitors for specific ID and upon receiving the specific ID, it forwards it along with the specific keyword to the signage server to identify information about the signage. The signage server uses the signage ID and the keyword to locate information about the advertisement and forwards the information to the signage application.

If the mobile device 13a or 13b does not receive sufficient GPS signals, the PDE 32 may use a combination of GPS and a pilot signal provided by a BTS, such as, for example, BTS associated with the base station 17 for position determination. To this end, if the mobile device 13a or 13b receives no GPS signals, PDE 32 may use the pilot signals provided by two or more of the BTSs, assuming there are sufficient numbers of them to enable trilateration, and may calculate through vector math the location of the mobile device 13a or 13b. Alternatively or additionally, if the mobile device 13a or 13b reports that it hears two or more pilot signals associated with two or more BTSs, PDE 32 identifies the location of the mobile device 13a or 13b to be in the area where the footprints of the two or more BTSs overlap. When the signage application receives a specific keyword relating to the signage, the signage application monitors for pilot signals provided by two or more of the BTSs and forwards the pilot signals, along with the specific keyword, to the signage server to identify information about the signage. The signage server uses the pilot signals and the keyword to locate information about the advertisement and forwards the information to the signage application.

In yet another alternative where the mobile device does not receive sufficient GPS signals, the mobile device may report ID of the pilot beacon signals located within a facility such as, for example, a mall. The pilot beacon may be placed indoors to extend coverage of the BTS from outside to inside. The pilot beacon may be associated with a specific ID and a specific location. The specific ID and the location may be registered at the PDE server. When the signage application receives a specific keyword relating to the signage, the signage application monitors for pilot beacon ID received from a pilot beacon and forwards the pilot beacon signal along with the specific keyword to the signage server to identify information about the signage. The signage server uses the pilot beacon signal and the keyword to locate information about the advertisement and forwards the information to the signage application.

Regardless of the methods used to identify the location information about the mobile device, as noted above the signage application forwards the location information and keyword to the signage server (Step 218). The signage server determines whether the location and the keyword received from the signage application matches the location information and the keyword received from the advertiser application. Upon determining that the location and the keyword received from the signage application matches the location information and the keyword received from the advertiser application, the signage server sends the resulting message to the signage application for display on the mobile device. Upon determining that the location and the keyword received from the signage application does not match the location information and the keyword received from the client application, the signage server sends a message to the signage application indicating no information relating to the submitted keyword within the proximity of the location of the mobile device can be identified. At the time of signup, the user can choose within the signage application their preferred method (either by messages or emails) of receiving communications (e.g., the advertisement content message) from the signage server.

The signage application receives the result from the signage server and displays the result to the user (Step 220). For example, the signage application may display one or more annotated signs that match the location and the keyword provided by the user. The annotated signs may include an image associated with a detected advertisement. Each image may be associated with a play icon, a save icon, and/or a delete icon. The play icon may be selected to view the annotated sign. The save icon may be selected to save the annotated sign. The delete icon may be selected to delete the annotation sign that might not be appealing to the user. After receiving the result, the user may then store the result or disregard the information (step 222). The result may be stored in a specific folder. The specific folder may include a title of the annotation along with a play icon for playing the annotation when selected by the user.

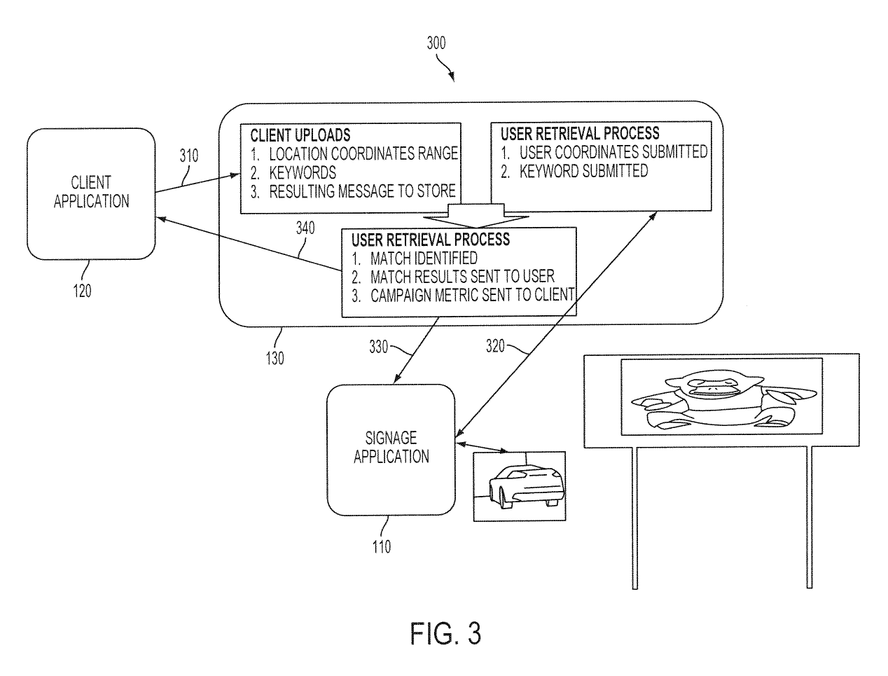

FIG. 3 illustrates an exemplary interaction 300 between the signage application, the client application, and the signage server. The signage application, the client application, and the signage server may respectively correspond to the signage application 110, the client application 120, and the signage server 130 described with respect to FIG. 1. The process 300 begins with the client application 120 registering at the signage server 130 information about the signage. To this end, the client application 120 uploads at the signage server 130 location coordinates range, keywords, and resulting message to be displayed to a user. The keyword may include a word associated with the signage that is likely to be remembered by the user when the user briefly sees the signage. To this end, the keyword may be a word that is prominently displayed on the signage or it may not be any specific word that is noted on the signage but one that is easily associated with a signage. In keeping with the previous example, the keyword may include “Pedemerge” and/or “pediatric service” for the signage relating to “Pedemerge,” a pediatrician service that opens 7 days a week.

If the keyword has already been registered within the proximity of the signage location, the signage server 130 may notify the advertiser. The signage server 130 may request that the advertiser choose a different keyword. To this end, the signage server 130 may help the advertiser in selecting alternative keywords that are not already registered within the signage server 130. In yet another alternative, the signage server 130 may allow the advertiser to keep the redundant keyword. This results in the display of multiple advertisements on the user's device when the commonly used keyword is submitted to the signage server 130.

The location coordinates relates to the physical location of the signage. In keeping with the previous example, the location may correspond to the physical location of the billboard along the freeway. The location associated with the signage may include a GPS location associated with the signage. Alternatively, the location associated with the signage may include a location associated with the Wi-Fi network providing short range connectivity to devices within an area where the signage is located. In yet another alternative, the location associated with the signage may include a location associated with a cell tower or pilot beacon providing mobile network connectivity to the signage.

The resulting message to store at the signage server 130 may include information associated with the signage that the advertiser would like the user to be able to access at a later time such as, for example, a website, phone number, name, or address of a business. In keeping with the previous example, the content may include the name, address and the phone number of “Pedemerge.” In some cases, the information provided to the user may be determined based on information about the user that is known at the signage server. For example, if “Pedemerge” is a national chain, the user may be notified of “Pedemerge” locations near the user's current location or near a default location (e.g., home or office location) of the user stored at the signage server 130 or at a data repository accessible to the signage server 130.

After receiving the client's uploads using the client application 120 (Step 310), the signage server 130 may receive from a signage application 110 on a mobile device, a request for information about the signage previously registered via the client application 120 (Step 320). The request may include a keyword associated with the signage and a location associated with the mobile device. The location associated with the mobile device includes a physical location of the mobile device. In keeping with the previous example, the location may correspond to the physical location of a car within the proximity of the billboard along the freeway. The location associated with the client device may include a GPS location associated with the client device. Alternatively, the location associated with the client device may include a location associated with the Wi-Fi network providing short range connectivity to the client device. In yet another alternative, the location associated with the client device may include a location associated with a cell tower or pilot beacon providing mobile network connectivity to the client device.

Upon receiving the user retrieval request (Step 320), the signage server 130 identifies the information associated with the previously registered signage. To do so, the signage server 130 determines whether the location and the keyword received from the signage application 110 matches the location and the keyword received from the client application 120. Upon determining that the location and the keyword received from the signage application 110 matches the location and the keyword received from the client application 120, the signage server 130 sends the resulting message to the signage application 110 for display on the mobile device (Step 330). The signage server 130 also sends campaign metric data to the client application 120 (Step 340). The campaign metric data may display campaign results for each specific campaign registered by the advertiser at the signage server 130. The campaign may relate to an advertising campaign and may be associated with one or more keywords. The result may display the frequencies of hits or queries received at the signage server 130 including the keyword overtime. The result may also include the number of times the campaign was displayed on the mobile devices and saved by the mobile devices.

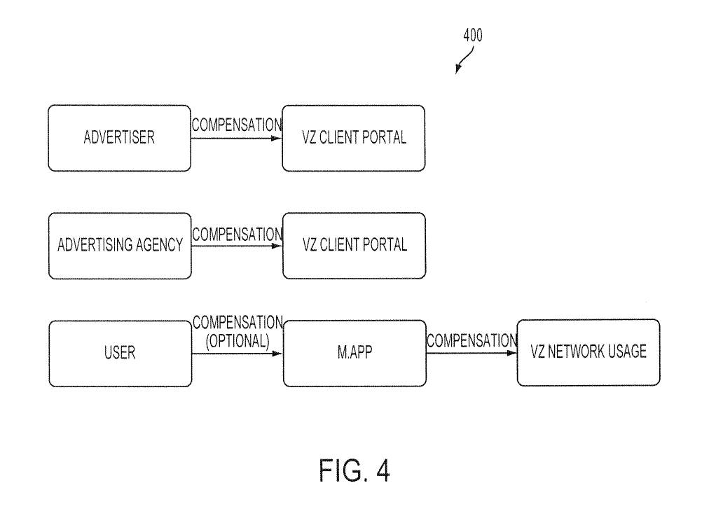

FIG. 4 illustrates an exemplary monetization 400 of the client application and the signage application. The signage application and the client application may respectively correspond to the signage application 110 and the client application 120 shown in FIG. 1. The client application 120 may be utilized by an advertiser. In this scenario, the advertiser may directly set up an independent advertisement or an array of advertisements and may register their corresponding information at the signage server. The registration may require payment of fees to the signage service provider. In one example, the signage service provider includes Verizon Wireless™. This may suit a scenario in which the advertiser owns the signage or has direct access to the signage such as, for example, a store front signage. The client application 120 may also be utilized by an advertising agency. In this scenario, the advertising agency such as, for example, a billboard owner pays to register the billboard and its information at the signage server 130. The signage application 110 may be utilized by the users. In one implementation, the user may have to pay to take advantage of the functionalities of the signage application 110. In another implementation, the user may be able to take advantage of the functionalities of the signage application for free. For example, Verizon Wireless™ may provide its subscribers with free access to the signage application; whereas, it may charge nonsubscribers a fee to access the signage application.

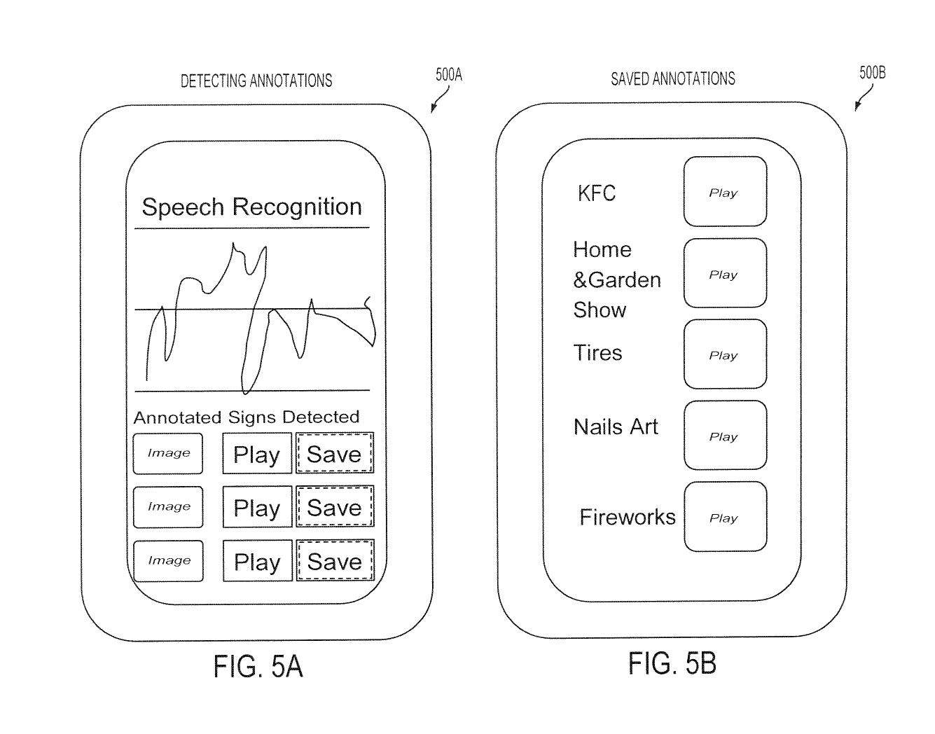

FIGS. 5A and 5B respectively illustrate an exemplary user interface 500A showing detected annotations and an exemplary user interface 500B showing saved annotations. The user interface 500A shows the annotated signs detected based on the keyword and location information provided by the signage application to the signage server. The keyword may be received in a form of a voice command and recognized by the voice recognition software of the mobile device. The mobile device may display the recognized voice command to the user so the user can confirm its accuracy. Each annotated sign includes an image icon, a play icon, and a save icon. The image icon may show an image of the signage. The play icon may be used to play detailed information about the signage. The save icon may be used to save the detailed information about the signage along with the image icon. Although not show, the user interface 500B may also include a delete icon configured to allow the user to delete one or more of the detected annotations that the user is not interested in.

The user interface 500B illustrates exemplary saved annotations. As noted above, the annotations may be saved by the save icon shown in user interface 500A of FIG. 5A. The saved annotations may include a title of the annotation along with a play icon. For example, the saved annotations may include annotations associated with “KFC,” “Home and Garden Show,” “Tires,” “Nails Art,” and “Fireworks.” Each of these annotations may correspond to an advertisement that the user may have encountered along his/her journey. The user was able to store an annotation relating to each advertisement without having to stop the user's journey to make some type of interaction with signage. That is, the user was able to maintain the user's mobility while still creating a personal annotation about the signage that can viewed by the user either immediately or at a later time.

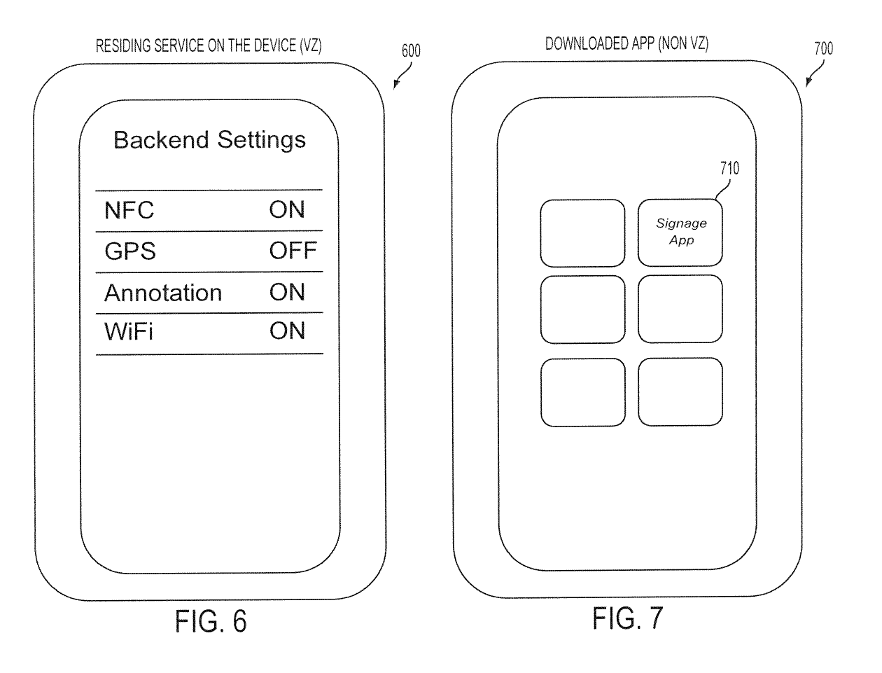

FIG. 6 illustrates exemplary backend settings 600 on the mobile device. The settings 600 include Near Field Communications (“NFC”), GPS, Annotation, and Wi-Fi settings. Each setting can be individually controlled and turned ON or OFF. The NFC setting allows the mobile device to contactlessly communicate with another NFC device or an NFC tag. For example, if activated it allows the mobile device to read information stored on the NFC tag when the mobile device becomes within the proximity of the NFC tag. For another example, it allows the mobile device to communicate payment information to the NFC reader. The GPS setting allows the mobile device to inform the network (e.g., the signage server 130 or PDE 32) of the location of the mobile device. For example, if activated, the GPS setting allows the mobile device to provide GPS location information to the signage server. The annotation setting allows the mobile device to detect and save annotations relating to signage that is viewed by the user without the user having to stop to interact with the signage. The Wi-Fi setting allows the mobile device to take advantage of the Wi-Fi network providing short range coverage for the mobile device.

FIG. 7 illustrates an exemplary application store interface 700 showing the available applications for download to the mobile device. As shown, one of the applications available for download includes the signage application 710. The signage application 710 may already be installed on the devices that subscribe to service provider providing the signage application functionality. If not already installed on the mobile device, the signage application 710 can be accessed via the mobile application store and may be downloaded on the mobile device.

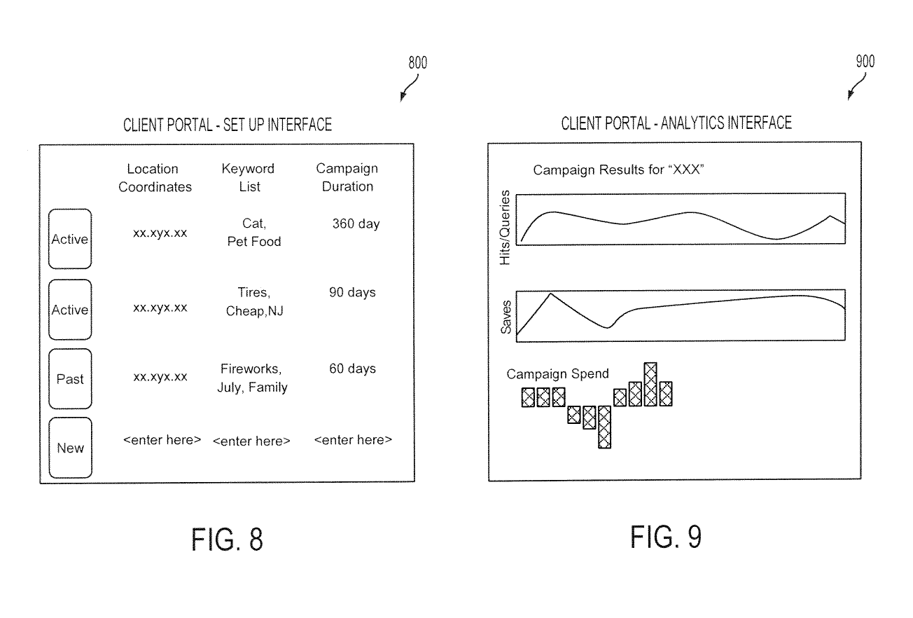

FIG. 8 illustrates an exemplary set up interface 800 for display on the client application. The client application may correspond to the client application 120 shown in FIG. 1. The user interface 800 shows several campaigns already registered with the signage server 130. Each campaign is associated with a different signage and includes status icon, location coordinates, keyword list, and campaign duration. The status icon indicates whether the duration of campaign is still active or it has expired. If the duration is active, the information about the campaign can still be found in the signage server 130. If the duration has expired, the information about the campaign may not be found in the signage server 130. The location coordinates show the location of the signage. The keyword list shows a list of keywords registered by the advertiser with the signage server 130. In one example, the keyword list shows “Cat” and “Pet Food” for one signage relating to cat food advertisement. In another example, the keyword list shows “Fireworks,” “July,” and “Family” for another signage relating to fireworks equipment for the fourth of July. The campaign duration shows the duration in which the campaign is valid with the signage server 130. For example, for the cat food advertisement, the campaign is valid for 360 days; whereas, for the fireworks equipment for the fourth of July, the campaign is valid only 60 days.

The set up interface 800 also includes a section for allowing the advertiser to register additional signage with the signage server 130. To register an additional signage, the advertiser may have to enter the location coordinates, keyword list, and the campaign duration in the set up interface 800. After entering this information, the advertiser may click a submit button to submit the information to the signage server 130.

FIG. 9 illustrates an exemplary analytics interface 900 that may be sent from time to time from the signage server to the client application. The signage server and the client application may respectively correspond to the signage server 130 and the client application 120 shown in FIG. 1. For each campaign registered with the signage server 130, the signage server 130 may sent campaign results to the advertiser. For example, the signage server 130 may monitor for each campaign the number of times there is a match between the keyword and the location submitted by the signage application 110 and the keyword and the location submitted by the client application 120. Based on the monitoring result, the signage server 130 may report the campaign metric to the advertiser. For example, the signage server 130 may report to the advertiser the number of times queries were submitted to the signage server 130 which matched the keyword “cat” and the location “xx.xyx.xx” during the campaign period. The signage server 130 may also report to the advertiser the number of times the user saved the campaign result on the user's mobile device. To this end, each time the user saves the campaign result on the mobile device, an indication may be sent from the signage application 110 to the signage server 130. The advertiser associated with the signage 115a or 115b and the client application 120 may determine, based on the results of the advertising campaign, whether to continue the advertising campaign and whether to create additional advertising campaigns (e.g., additional signages in different locations). The advertiser may also learn which keywords are typically being used to access his/her advertisements. For example, an advertiser may learn that the keywords “cat” and “pet food” are successful in the campaign, while the words “dog” and “dog food” are not successful. The advertiser may modify its strategies (e.g. what is featured in its advertisements, which additional keywords to request, etc.) based on the successful keywords in the campaign.

Those skilled in the art presumably are familiar with the structure, programming, and operations of the various types of mobile devices. However, for completeness, it may be useful to consider the functional elements/aspects of two exemplary mobile devices 13a and 13b, at a high-level.

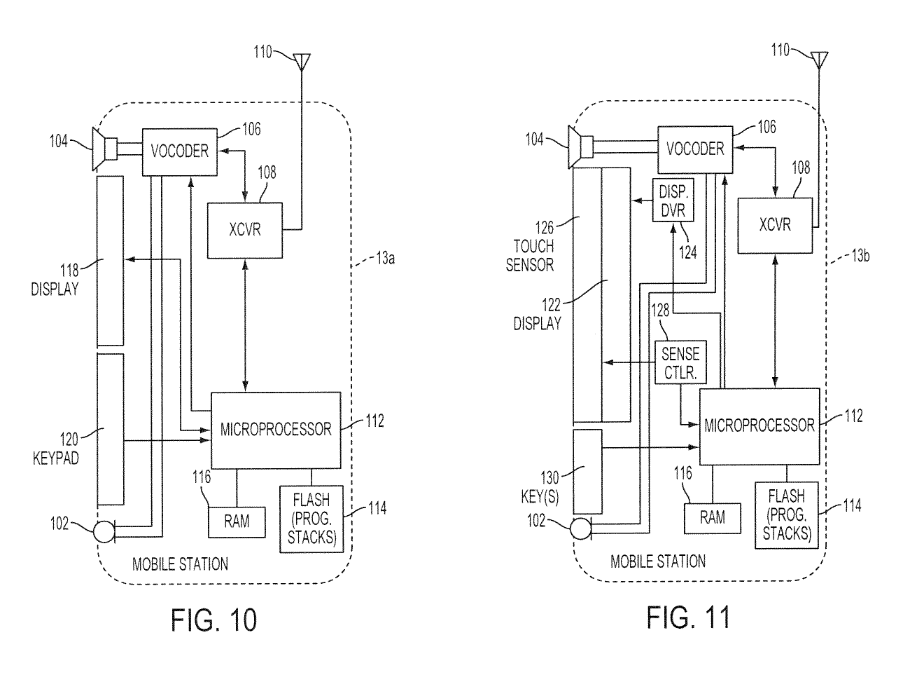

For purposes of such a discussion, FIG. 10 provides a high-level functional block diagram of an exemplary non-touch type mobile device 13a that may utilize the signage service through a network/system like that shown in FIG. 1. Although the mobile device 13a may be a smart-phone or may be incorporated into another device, such as a personal digital assistant (PDA) or the like, for discussion purposes, the illustration shows the mobile device 13a is in the form of a handset. The handset implementation of the mobile device 13a functions as a normal digital wireless telephone station. For that function, the station 13a includes a microphone 102 for audio signal input and a speaker 104 for audio signal output. The microphone 102 and speaker 104 connect to voice coding and decoding circuitry (vocoder) 106. For a voice telephone call, for example, the vocoder 106 provides two-way conversion between analog audio signals representing speech or other audio and digital samples at a compressed bit rate compatible with the digital protocol of wireless telephone network communications or voice over packet (Internet Protocol) communications.

For digital wireless communications, the handset 13a also includes at least one digital transceiver (XCVR) 108. Today, the handset 13a would be configured for digital wireless communications using one or more of the common network technology types. The concepts discussed here encompass implementations of the mobile device 13a utilizing any digital transceivers that conform to current or future developed digital wireless communication standards. The mobile device 13a may also be capable of analog operation via a legacy network technology.

The transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile device 13a and the communication network. Each transceiver 108 connects through RF send and receives amplifiers (not separately shown) to an antenna 110. The transceiver may also support various types of mobile messaging services, such as short message service (SMS), enhanced messaging service (EMS) and/or multimedia messaging service (MMS).

The mobile device 13a includes a display 118 for displaying messages, menus or the like; call related information dialed by the user, calling party numbers, etc. A keypad 120 enables dialing digits for voice and/or data calls as well as generating selection inputs, for example, as may be keyed-in by the user based on a displayed menu or as a cursor control and selection of a highlighted item on a displayed screen. The display 118 and keypad 120 are the physical elements providing a textual or graphical user interface. Various combinations of the keypad 120, display 118, microphone 102 and speaker 104 may be used as the physical input output elements of the graphical user interface (GUI), for multimedia (e.g., audio and/or video) communications. Of course other user interface elements may be used, such as a trackball, as in some types of PDAs or smart phones.

In addition to normal telephone and data communication related input/output (including message input and message display functions), the user interface elements also may be used for display of menus and other information to the user and user input of selections, including any needed during signage service.

A microprocessor 112 serves as a programmable controller for the mobile device 13a, in that it controls all operations of the mobile device 13a in accord with programming that it executes, for all normal operations, and for operations involved in signage service under consideration here. In the example, the mobile device 13a includes flash type program memory 114, for storage of various “software” or “firmware” program routines and mobile configuration settings, such as mobile directory number (MDN) and/or mobile identification number (MIN), etc. The mobile device 13a may also include a non-volatile random access memory (RAM) 116 for a working data processing memory. Of course, other storage devices or configurations may be added to or substituted for those in the example. In a present implementation, the flash type program memory 114 stores firmware such as a boot routine, device driver software, an operating system, call processing software and vocoder control software, and any of a wide variety of other applications, such as client browser software and short message service software. The memories 114, 116 also store various data, such as telephone numbers and server addresses, downloaded data such as multimedia content, and various data input by the user. Programming stored in the flash type program memory 114, sometimes referred to as “firmware,” is loaded into and executed by the microprocessor 112.

As outlined above, the mobile device 13a includes a processor, and programming stored in the flash memory 114 configures the processor so that the mobile device is capable of performing various desired functions, including in this case the functions involved in the technique for querying and receiving annotations relating to signage from the signage server. For example, any of the modules of the signage application 100 or any parts of the modules can be located on the mobile device 13a.

For purposes of such a discussion, FIG. 11 provides a high-level functional block diagram of an exemplary touch screen type mobile device 13b that may utilize the signage service through a network/system like that shown in FIG. 1. Although possibly configured somewhat differently, at least logically, a number of the elements of the exemplary touch screen type mobile device 13b are similar to the elements of mobile device 13a, and are identified by like reference numbers in FIG. 6. For example, the touch screen type mobile device 13b includes a microphone 102, speaker 104 and vocoder 106, for audio input and output functions, much like in the earlier example. The mobile device 13b also includes at least one digital transceiver (XCVR) 108, for digital wireless communications, although the handset 13b may include an additional digital or analog transceiver. The concepts discussed here encompass implementations of the mobile device 13b utilizing any digital transceivers that conform to current or future developed digital wireless communication standards. As in the station 13a, the transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile device 13b and the communication network. Each transceiver 108 connects through RF to send and receive amplifiers (not separately shown) to an antenna 110. The transceiver may also support various types of mobile messaging services, such as short message service (SMS), enhanced messaging service (EMS) and/or multimedia messaging service (MMS).

As in the example of station 13a, a microprocessor 112 serves as a programmable controller for the mobile device 13b, in that it controls all operations of the mobile device 13b in accord with programming that it executes, for all normal operations, and for operations involved in the signage service under consideration here. In the example, the mobile device 13b includes flash type program memory 114, for storage of various program routines and mobile configuration settings. The mobile device 13b may also include a non-volatile random access memory (RAM) 116 for a working data processing memory. Of course, other storage devices or configurations may be added to or substituted for those in the example. Hence, outlined above, the mobile device 13b includes a processor, and programming stored in the flash memory 114 configures the processor so that the mobile device is capable of performing various desired functions, including in this case the functions involved in the technique for providing signage service.

In the example of FIG. 10, the user interface elements included a display and a keypad. The mobile device 13b may have a limited number of key 130, but the user interface functions of the display and keypad are replaced by a touch screen display arrangement. At a high level, a touch screen display is a device that displays information to a user and can detect occurrence and location of a touch on the area of the display. The touch may be an actual touch of the display device with a finger, stylus or other object, although at least some touch screens can also sense when the object is in close proximity to the screen. Use of a touch screen display as part of the user interface allows a user to interact directly with the information presented on the display.

Hence, the exemplary mobile device 13b includes a display 122, which the microprocessor 112 controls via a display driver 124, to present visible outputs to the device user. The mobile device 13b also includes a touch/position sensor 126. The sensor 126 is relatively transparent, so that the user may view the information presented on the display 122. A sense circuit 128 sensing signals from elements of the touch/position sensor 126 and detects occurrence and position of each touch of the screen formed by the display 122 and sensor 126. The sense circuit 128 provides touch position information to the microprocessor 112, which can correlate that information to the information currently displayed via the display 122, to determine the nature of user input via the screen.

The display 122 and touch sensor 126 (and possibly one or more keys 130, if included) are the physical elements providing the textual and graphical user interface for the mobile device 13b. The microphone 102 and speaker 104 may be used as additional user interface elements, for audio input and output, including with respect to some directional messaging related functions.

The structure and operation of the mobile devices 13a and 13b, as outlined above, were described by way of example, only. As shown by the above discussion, functions relating to the signage service may be implemented on computers connected for data communication via the components of a packet data network, operating as shown in FIG. 1. Although special purpose devices may be used, such devices also may be implemented using one or more hardware platforms intended to represent a general class of data processing device commonly used to run “server” programming so as to implement the signage service discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for directional messaging service. The software code is executable by the general-purpose computer that functions as the directional messaging platform and/or that functions as a user terminal device. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for directional messaging service, in essentially the manner performed in the implementations discussed and illustrated herein.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for the signage service. The software code is executable by the general-purpose computer that functions as the signage server, that functions as a client device including a client application, and/or that function as a user's mobile device including a signage application. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for receiving annotations relating to signage, in essentially the manner performed in the implementations discussed and illustrated herein.

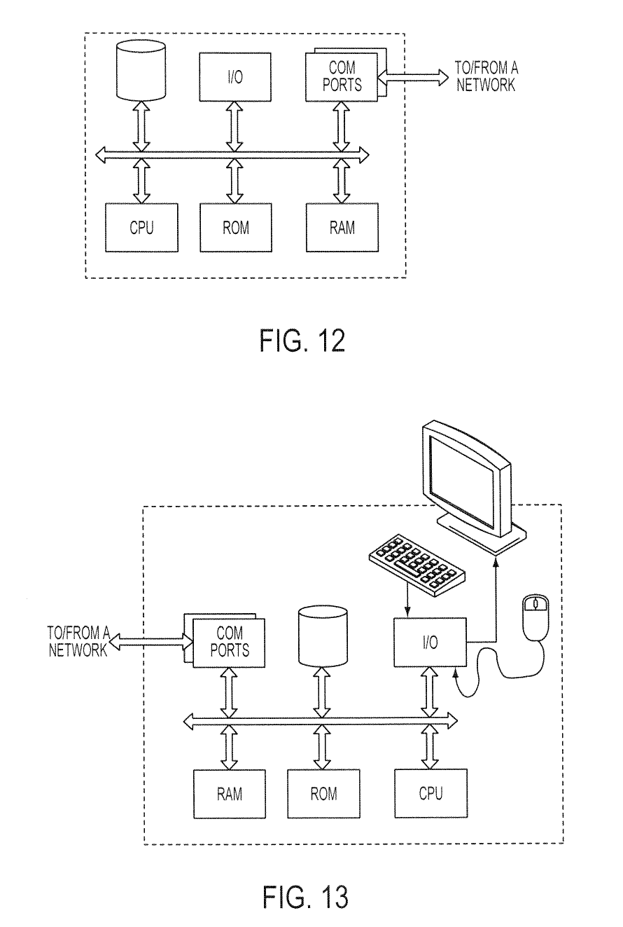

FIGS. 12 and 13 provide functional block diagram illustrations of general purpose computer hardware platforms. FIG. 12 illustrates a network or host computer platform, as may typically be used to implement a server. FIG. 13 depicts a computer with user interface elements, as may be used to implement a personal computer or other type of work station or terminal device, although the computer of FIG. 6 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

Hence, aspects of the methods of receiving annotations relating to signage outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network provider into the signage server. Such communications may also enable loading of the software from the signage server to a user's mobile device and to a client device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the signage service, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The signage platform of the instant application includes a client application, a signage application, and a signage server. Using the client application, the advertisers and the billboard owner can register their signage with the signage server. The information may include location of the signage, keyword list, and campaign duration. When the mobile user sees the signage, the mobile user can use the signage application on his or her mobile device to query the signage server about the registered information. The query may include a keyword and a location of the mobile device. Responsive to the query, the signage server attempts to match the keyword and location submitted by the signage application with a keyword and location submitted by the client application during the registration. If there is match, the information about the signage may be sent to the signage application for display to the user. If there is no match, the information about lack of a match may be communicated to the signage application for display to the user.

There are several components that make the proposed signage platform unique. Firstly, unlike existing solutions, the signage platform of the instant application allows consumers to decide when they want relevant signage direct messaging to happen, without having to stop their mobility. Secondly, unlike the existing solutions, the signage platform allows clients to signage message to consumers by user actively triggering location based search engine optimization which does not require clients to have a subscription or contract exclusive with a signage networks. The clients may only be required to register for the signage service provided by the mobile service provider. To this end, the solution proposed presents strategic value to the signage service provider (e.g., Verizon Wireless™) and to the market.

Up until present, user interaction with signage has been limited to visual cues for human memory, requiring active engagement (take photo, QR reading), or requiring a dedicated 1 to 1 (mobile application to beaconing technologies) relationship within a specific network of non-cellular machines. These solutions may lack the ability to utilize the carrier networks like Verizon™ or offer a unique approach for client and users to be able to interact with signage using existing cellular network infrastructure. To elaborate, the existing messaging between user device and signage may be enabled by only exclusive provisioning of the signage company. These solutions may also lack the ability to create a strategic response to over-the-top (OTT) solutions that are offered in the market that bypasses carrier.

Other implementations are contemplated. For example, although the instant application was described with respect to a billboard signage along the highway, other usages are contemplated. Specifically, the signage service of the instant application may be used by a driveway sealer who just finished sealing a driveway. He may put up a temporary sign with the owner's permission on the driveway. He may then register the temporary sign on the signage server for a limited time. Users that drive by the house see the sign and can query the signage server for information for “driveway sealing” and be directed to the information for driveway sealer. In a few days, the owner of the house may remove the temporary sign. In another example, a local landscaper may sell firewood during certain season and when he has sufficient supply from cutting trees. The landscaper may put up a sign and register the sign for a limited time. When users walk or drive by, they can query the signage server for information for fire wood and be directed to the local landscaper. In some cases, the landscaper may indicate to the signage server 130 how much firewood is available and when the supply of firewood is depleted. The indication may be transmitted to the signage server over a network through an application programming interface (API) provided by the signage server 130. This technology may be used for any limited supply goods or services, not only firewood. For example, a family whose dog had puppies may create a signage advertising that the puppies are available for sale. The family may indicate, using the API, the number of puppies available and when any of the puppies are sold. After all of the puppies are sold, the additional information provided to the mobile devices accessing the signage may indicate that there are no more puppies available. In yet another example, a local store front window may have a LCD display that displays a several ads one at a time. The display may be registered for the signage service and the different ads are noted. When a user walks by and sees the ads, the user can query the signage server for additional information. By using the location and key words, the signage server can identify the location of the display and the ad (of several ads) in question and sends the information to the user.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving, at a signage application of a mobile device, a request for information relating to a signage, the request including a keyword associated with the signage;
responsive to the request, identifying a location associated with the mobile device;
sending, from the signage application to a signage server, the location and the keyword to receive the requested information about the signage; and
receiving, from the signage server and at the signage application, the requested information about the signage.

2. The method of claim 1, further comprising activating the signage application using a voice command prior to receiving the request.

3. The method of claim 1, further comprising activating the signage application using a speed of travel associated with the mobile device prior to receiving the request.

4. The method of claim 1, further comprising activating the signage application upon determining a navigation system in a vehicle in which the mobile device is disposed has turned ON.

5. The method of claim 1, wherein receiving the request includes receiving a voice command from the user including the keyword associated with the signage.

6. The method of claim 1, wherein identifying the location associated with the mobile device includes identifying a Global Positioning System (GPS) location associated with the mobile device.

7. The method of claim 1, wherein identifying the location associated with the mobile device includes:
identifying a Wi-Fi network providing connectivity to the mobile device;
identifying a location associated with the Wi-Fi network; and
identifying the location associated with the mobile device as the location associated with the Wi-Fi network.

8. The method of claim 1, wherein identifying the location associated with the mobile device includes:
identifying a location of a cell tower providing mobile network connectivity to the mobile device; and
identifying the location associated with the mobile device as the location of the cell tower.

9. The method of claim 1, wherein:
sending the location and the keyword to the signage server includes sending the location and the keyword to the signage server over a mobile communication network to allow the signage server to pair the location and the keyword with a location and a keyword associated with the signage, and
the signage includes an advertisement signage.

10. The method of claim 1, further comprising:
displaying the requested information about the signage on the mobile device;
receiving, at the signage application, an instruction to store or disregard the requested information about the signage; and
responsive to the received instruction, storing or disregarding the requested information about the signage.

11. The method of claim 1, wherein receiving the request includes receiving the request without the mobile device directly facing the signage.

12. A method comprising:
receiving, at a signage server and from a signage application on a mobile device, a request for information about an advertisement, the advertisement having a physical display at a stored stationary geographic location, the request including a keyword associated with the advertisement and a location associated with the mobile device;
based on the keyword and based on the location of the mobile device being within a predetermined radius of the stored stationary geographic location of the advertisement, identifying the information associated with the advertisement; and
sending, from the signage server to the signage application, the information associated with the advertisement.

13. The method of claim 12, further comprising:
receiving, prior to receiving the request for information form the signage application on the mobile device, from an advertiser platform, a request to register the advertisement, the request including location information associated with the advertisement, a keyword, and a resulting message to be displayed on the signage application; and
responsive to the request to register the advertisement, and prior to receiving the request for information form the signage application on the mobile device, registering the advertisement in a database along with the location information, the keyword, and the resulting message received from the advertiser.

14. The method of claim 13, wherein identifying the information associated with the advertisement includes:
determining whether the location and the keyword received from the signage application matches the location information and the keyword received from the advertiser platform; and
upon determining the location and the keyword received from the signage application matches the location information and the keyword received from the advertiser platform, sending the resulting message to the signage application for display on the mobile device.

15. The method of claim 12, further comprising:
receiving, prior to receiving the request for information form the signage application on the mobile device, from an advertiser platform, a request to register the advertisement, the request including location information associated with the advertisement, a keyword, and a resulting message to be displayed on the signage application;
determining that the keyword is already stored in a data repository associated with the signage server; and
responsive to determining that the keyword is already stored in the data repository, informing a user at the advertiser platform that the keyword is already stored and instructing the user at the advertiser platform to select another keyword.

16. The method of claim 12, wherein:
receiving the request for information about the advertisement includes receiving the request over a mobile communication network, and
sending the information associated with the advertisement includes sending the information associated with the advertisement over the mobile communication network.

17. The method of claim 12, wherein the location associated with the mobile device includes a GPS location associated with the mobile device.

18. The method of claim 12, wherein receiving the request including the location associated with the mobile device includes receiving the request identifying a Wi-Fi network providing to the mobile device, the method further comprising:
identifying a location associated with the Wi-Fi network; and
identifying the location associated with the mobile device as the location associated with the Wi-Fi network.
